(19) United States
(12) Patent Application Publication
(10) Pub. No.: US 2014/0034578 A1
(43) Pub. Date: Feb. 6, 2014

(54) BIODEGRADABLE FILTER USING COCONUT DERIVED ACTIVATED CARBON AND CITRICIDAL

(71) Applicants: James Patrick Abulencia, Bronx, NY (US); Susan M Gallardo, Manila (PH); Francis Narvin Tanala, Manila (PH)

(72) Inventors: James Patrick Abulencia, Bronx, NY (US); Susan M Gallardo, Manila (PH); Francis Narvin Tanala, Manila (PH)

(21) Appl. No.: 13/803,216

(22) Filed: Mar. 14, 2013

Related U.S. Application Data
(60) Provisional application No. 61/689,730, filed on Jun. 11, 2012.

(30) Foreign Application Priority Data
Jun. 14, 2012 (PH) 12012000161

(51) Int. Cl. C02F 1/28

(52) U.S. Cl. CPC C02F 1/281
USPC 210/668; 210/348; 210/500.1; 210/502.1

(57) ABSTRACT

A filter intended to remove pollutants from water in developing countries can include two stages connected in series. The first stage can be coconut derived activated carbon embodied in a bamboo housing and used to remove heavy metals and pesticides. The second stage can also be coconut derived activated carbon mixed with citricidal, and used to remove bacteria. Contaminated water traverses from the first stage to the second via gravity flow, resulting in water that is free of heavy metals and bacteria.

This application claims priority from U.S. Provisional Application Ser. No. 61/689,730, filed Jun. 11, 2012, the disclosure of which is hereby incorporated by reference in its entirety. This application also claims priority to Philippine Patent Application 12012000161 filed Jun. 14, 2012. The entirety of this application is incorporated by reference herein.

### BACKGROUND

In all societies, there is a need for clean filtered water. In rural and developing countries, the need is urgent as the population requires a potable water supply. In developed nations, while potable water is available, there is still a need by some of the populous to further filter the potable water. This has led to the proliferation of both home and personal filters and bottled water, which are marketed as better filtered than the domestic potable water supply, which may or may not be the case in all circumstances.

This desire for populations to further filter already potable water has led to the use and subsequent disposal of many materials. Typical personal filters are one time use, being disposed once at capacity. Further, there is a massive amount of plastic being used and disposed of for bottling water. Thus there is a need to be able to filter water and still reduce the amount of waste involved in the process. The filter should be simple enough for rural populations to quickly and inexpensively have potable water and be reusable or biodegradable to solve the waste issues involved with bottled water.

### SUMMARY

The advantage of the present invention is its use of biodegradable materials in the water filtration device. The proposed water filter is 100% recyclable and biodegradable, which will mitigate the release harmful toxins, particulates, and greenhouse gases produced by incineration. Further, use of local biodegradable products allow rural populations to inexpensively have the potable water they need without complex devices or expensive equipment.

In addition to being utilized in a rural setting, the filters can be used as a portable 100% biodegradable filter in any part of the world. The filter waste is available for biodegradable refuse, recyclable projects, or simply reused. In such a capacity, these filters can drastically curtail the need to buy bottled water and therefore diminish the use of plastic bottles that produce harmful environmental impacts.

### BRIEF DESCRIPTION OF THE DRAWINGS

FIG. 1: Schematic of Filter Device 100.
FIG. 1-A: Detailed Drawing of the First Chamber or Stage 102. In one embodiment the Length is 46 cm, the inside diameter is 7 cm, the outside diameter is 7.8 cm, and the thickness is 0.4 cm. In one embodiment the diameter of the holes 120 in the bottom 109 of the chamber is 3 mm.
FIG. 1-B: Strainer 108. Cheesecloth can be used as a strainer 108 to be placed at the bottom 109 of the first stage 102. For example, it can be cut in a rectangle with a length of 61 cm and a width of 22 cm.
FIG. 1-C: First Stage Strainer 108 (i.e., something place upon the bottom 109 of the first stage 102 so that the activated carbon 106 does not fall out). A rectangular piece of strainer material (see FIG. 1-B) can be sewn from edge to edge to form a cylinder and the circular part will be sewn to the bottom 109 in order to create a filter bag.

FIG. 2: FTIR Spectra for the activated carbon (“AC”) Samples

FIG. 3: Results of pH Drift Tests for the ITDI-AC Sample

FIG. 4: Batch Test Results on the Effect of Adsorbent Dosage

FIG. 5: Continuous Test Results on the Effect of Contact Time

FIG. 6: Adsorption Isotherm of ITDI-AC

FIG. 7: Effect of Adsorbent Dosage on Methomyl Removal

FIG. 8: E-Coli Inhibition vs. Water Volume Treated with 0.3 grams AC and 30 mg citricidal

### DETAILED DESCRIPTION

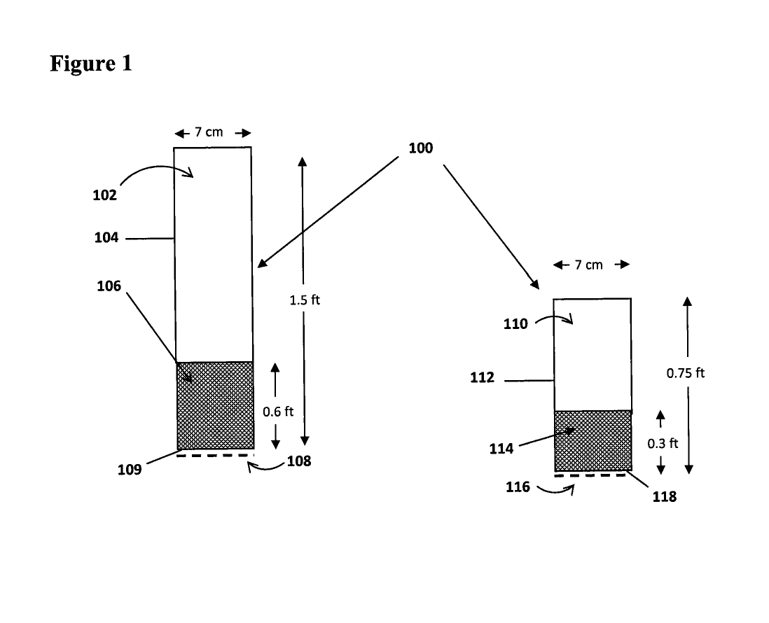

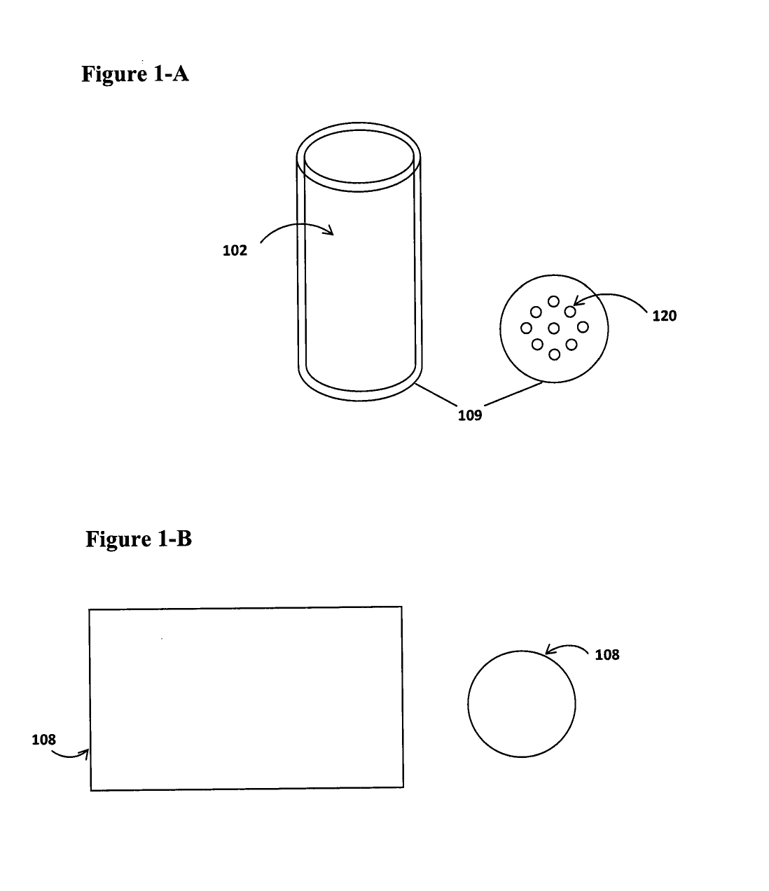

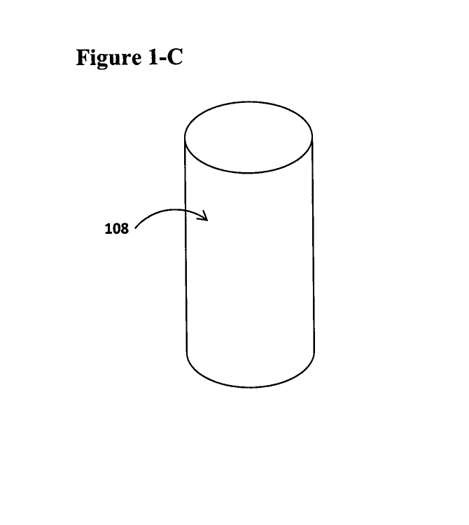

The device described is a portable water purification solution that effectively treats contaminated water, and is primarily intended for communities in developing countries. This device can also be used commercially to provide a fully biodegradable personal water filtration solution. More specifically examples of the present invention can a) remove heavy metals, b) remove pesticides, and c) disinfect liquids (e.g., water). The device can include two stages arranged serially (FIG. 1).

Filter Design:

In one example, the filter 100 can have the two stage (102,110) design because of the different effective lifetimes each material can be used in service. More specifically, the stage containing the citricidal becomes ineffective quicker than the stage containing solely activated carbon. Because of the two stage design, activated carbon that is still viable is not disposed with the stage containing the spent citricidal. However, if other local materials are used, a single stage with both the contaminate filter 106 and the disinfecting filter 114 can be incorporated.

In some embodiments, contaminated water or fluid is placed in the first chamber or stage 102 (FIG. 1-A) containing the contaminate filter 106. In one embodiment, a first stage strainer 108 can be placed at the bottom 109 of the first stage 102. In this example, the “bottom” 109 is the end opposite the end the contaminated water flows into. For example, cheesecloth can be used as the strainer 108 and placed at the bottom 109 of the first stage 102 to filter the solid impurities and to prevent the contaminate filter 106 from entering the flow-through (FIG. 1).

The contaminate filter 106 removes impurities like heavy metals and pesticides as a function of the known properties of activated carbon filtration. Once passed through the first stage 102, the decontaminated water is passed into the second stage 110 (FIG. 1).

The second stage 110 houses the disinfecting filter 114 containing a filtering agent, which can be activated carbon and/or citricidal. The second stage 110 can also include a second stage strainer 116. In an example, the second stage strainer 116 can be cheesecloth placed at the “bottom” 118 of the second stage 110. The second stage can abate or kill E-Coli and other bacteria. The resulting fluid will now be purified (e.g., purified water).

The filter 100 includes a first stage 102. The first stage housing 104 of the first stage 102 can be made of local materials, in one example bamboo. The housing forms a volume to contain a contaminate filter 106. In an example, the contaminate filter 106 is made of coconut derived activated carbon. Functionally, the contaminate filter 106 is responsible for removing the heavy metals and pesticides.

The second stage 110 can have a second stage housing 112. The second stage housing 112 can be made from local material, like bamboo. The materials of the first and second stage housings 104, 112 can be the same or different, depending on the local materials at hand.

The second stage housing 112 forms a second volume to contain a disinfecting filter 114. In one embodiment, the disinfecting filter 114 is made of a mixture of coconut derived activated carbon with citricidal. The second stage 110 of the filter 100 can be responsible for disinfecting the water.

Both stages 102, 110 can have holes 120 disposed at the bottom 109, 118 of the stages to help retain their respective filtration materials 106, 114 but still allow the water to pass there through.

The two stages, 102, 110, can be connected together by stacking the stages on top of each other, or by collecting the effluent from the first stage 102 and then feeding it to the second stage 110. In one embodiment the two stages are not connected and, the water is collected from the first stage 102. The water can be collected into a container such as, but not limited to, a basin, holding tank, a jug, a bottle, a cup, a bowl, a ladle, a dipper, a glass, a flask, a water bag, or bladder, or a growler. The container can be made of clay, glass, metal, ceramic, cement, or synthetic material (e.g., plastic or rubber). In one embodiment the container is connected directly to the stage (e.g., screwed onto, snapped onto, latched onto, etc.) In one embodiment liquid citricidal is added to the basin. In another embodiment the second filter contains AC and powder citricidal. In yet another embodiment, citricidal is added to the basin and is present in the second filter.

In one example, the first and second stages 102, 110 are made of bamboo. The top portion of the bamboo is removed leaving a hollow cylinder with solid bottom 109, 118. Holes 120 are then drilled into the bottom 109, 118. In one embodiment the holes 120 can been drilled at random. In another embodiment the holes 120 can be drilled into a pattern. There may be 3, 4, 5, 6, 7, 8, 9, 10, 11, 12, 13, 14, or 15 holes. The holes can be 1, 2, 3, 4, 5, 6, 7, 8, 9, 11, 12, 13, 14, or 15 cm.

Contaminated water traverses from the first stage to the second via gravity flow resulting in water that is free of heavy metals, bacteria, and pesticides. In one embodiment there is enough free space on the top to accommodate the disruption of the AC bed at high flow rates. The flow rate maintained such that the liquid has ample time to be in contact with the disinfectant

In one embodiment, there is a lid at the top of the first and/or second stage 102, 110. A lid may be used after water is initially added to prevent additional contaminants from entering the water. In another embodiment, the second stage is extends beyond the bottom 118 such that it is able to be screwed or attached onto a water bottle or other collection device.

In one embodiment 400 grams of activated carbon is added to the first stage, and 206 grams of activated carbon in the second stage. The volume ratio between the two stages can be the same or different. In another embodiment the AC occupies 30-50% of the volume of the first stage. In another embodiment, the AC occupies about 25-60% of the volume of the first stage. In yet another embodiment, the AC occupies about 35-45% of the volume of the first stage. In another embodiment the AC occupies about 35%, about 40%, about 45%, about 50%, about 55%, or about 60% of the volume of the first stage. In another embodiment the AC occupies 30-50% of the volume of the second stage. In another embodiment, the AC occupies about 25-60% of the volume of the second stage. In yet another embodiment, the AC occupies about 35-45% of the volume of the second stage. In another embodiment the AC occupies about 35%, about 40%, about 45%, about 50%, about 55%, or about 60% of the volume of the second stage.

The source and method of generating activated carbon plays a role in the absorption characteristics of the activated carbon. The activated carbon can be made from, but not limited to, wood, nutshells, coconut shell and other agricultural materials (e.g., apricot stone, bamboo, olive pits), lignite coal, anthracite coal, peat, petroleum pitch, and other suitable material.

In one embodiment the coconut shell is used to make the activated carbon. For example, in one embodiment the shell or husk of cocos nucifera can be utilized. Any variety of coconut can be used, for example, but not limited to nui kafa, niu vai, West African Tall or, the Tampakan Tall. In one embodiment the Activated carbon is produced by using hot gases. For example, the carbon containing material is pyrolyzed at temperatures in the range of 600-900° C. This is conducted in absence of oxygen and usually in the present of an inert atmosphere with gases such as argon or nitrogen. Activated carbon can also be produced by exposing the carbonised material to oxidizing atmospheres at temperatures above 250° C. Activated carbon can also be produced by impregnating the raw material with certain chemicals such as an acid, a strong base, or a salt (e.g., phosphoric acid, potassium hydroxide, sodium hydroxide, calcium chloride, and zinc chloride 25%) The raw material is then carbonized at lower temperatures (450-900° C.). In some embodiments the carbonization/activation step proceeds simultaneously with the chemical activation.

The activated carbon can be a fine powder, pills, or flakes. In one embodiment the range in particle size can be about 0.5 to about 0.60 mm. In another embodiment the particle size can range from about 0.45 to about 0.7 mm. In another embodiment the range of particle size can be about 0.55 mm to about 0.8 mm. The particle size can be about 0.4, about 0.45, about 0.5, about 0.55, about 0.6, about 0.65, or about 0.7 mm.

The stage housing 104, 112 can be made from, but not limited to, bamboo, Japanese knotweed, Bohemian knotweed, Mexican bamboo, smartweed, cactus, sugar cane, river cane, canebreak bamboo, or hollowed out tree or shrub limbs. For example, in the Philippines bamboo is a native plant and is ideal to make the stage housing because of its strength and durability. In other embodiments, non-natural material can be used to create the filter such as recycled material, wax covered paper, metal, clay, or other synthetic material. In one embodiment, the stage housing 104, 112 can have an inner diameter of can range from about 2 inches to about 4 inches. In other embodiment, the inner diameter can range from about 1 inch to about 5 inches. In another embodiment, the inner diameter can range from about 1.5 inches to about 4.5 inches. The inner diameter can be about 1 inch, about 1.5 inches, about 2 inches; about 2.25 inches; about 2.5 inches, about 2.75 inches, about 3 inches, about 3.25 inches, about 3.5 inches, about 3.75 inches, about 4 inches, about 4.25 inches, about 4.5 inches, about 4.75 inches, about 5 inches, about 5.25 inches, or about 5.5 inches.

The thickness of the housing 104, 112 can be about ⅛ of an inch to about ¼ of an inch. In other embodiments, the thickness of the housing can be about ⅛ of an inch to about ½ of an inch. In another embodiment, the thickness can be about 1/10 of an inch to about ¾ of an inch. In yet another embodiment, the thickness can be about ⅙ of an inch to about ½ of an inch. In one embodiment the thickness is about 1/10 of an inch, about 1/9 of an inch, about ⅛ of an inch, about 1/7 of an inch, about ⅙ of an inch, about ⅕ of an inch, about ¼ of an inch, about ⅓ of an inch, about ½ of an inch, about ¾ of an inch, or about ⅔ of an inch.

The length of the first stage 102 can be about 1 foot to 3 feet. In one embodiment the first stage 102 can be about 1 foot to about 2.5 feet in length. In another embodiment, the length of the first stage 102 can be about 1.5 feet to about 2.5 feet. In yet another embodiment, the length can be about 1.75 feet to about 2.5 feet. In some embodiments, the length of the first stage can be about 1 foot, about 1.25 feet, about 1.5 feet, about 1.6 feet, about 1.7 feet, about 1.8 feet, about 1.9 feet, about 2 feet, about 2.1 feet, about 2.2 feet, about 2.3 feet, about 2.4 feet, about 2.5 feet, about 2.6 feet, about 2.7 feet, about 2.8 feet, about 2.9 feet, about 3 feet, about 3.25 feet, about 3.5 feet, about 3.75 feet, about 4 feet, or about 5 feet.

The length of the second stage 110 can be about 1 foot to 2 feet. In one embodiment the second stage 110 can be about 0.5 feet to about 2.5 feet in length. In another embodiment, the length of the second stage 110 can be about 0.75 feet to about 2.25 feet. In yet another embodiment, the length can be about 1.25 feet to about 2.3 feet. In some embodiments, the length of the second stage can be about 0.5 foot, about 0.6 feet, about 0.7 feet, about 0.8 feet, about 0.9 feet, about 1 foot, about 1.1 feet, about 1.2 feet, about 1.3 feet, about 1.4 feet, about 1.5 feet, about 1.6 feet, about 1.7 feet, about 1.8 feet, about 1.9 feet, about 2 feet, about 2.1 feet, about 2.2 feet, about 2.3 feet, about 2.4 feet, about 2.5 feet, or about 2.6 feet.

The strainer 108, 116 can be cheesecloth, smooth-woven fabric, a fine mesh colander, wire strainer, coffee filter, tea towel, flour sack, nylon hose, as well as other suitable biodegradable material. Used or new articles of clothing can also be used, such as t-shirts, sheets, panty hose, tights, handkerchiefs, and the like.

In some embodiments the disinfectant is citric seed extract. In one embodiment citricidal is used as the disinfectant. Citricidal can be obtained from grapefruit seed/pulp extract. Citricidal can also be obtained from commercial sources such as Nutribiotic, Higher Nature, Health Leads, Viridian, and Vitamin Shoppe.

In some embodiments, citricidal can be replaced by or augmented (i.e., used along with) by other natural antibiotics such as, but not limited to, ginger, lemon juice, garlic, Echinacea, colloidal silver, pau d'arco, manuka honey, goldenseal, myrrh, coconut oil, oregano essential oil, high dose vitamin D, high dose vitamin C, high dose vitamin A, iodine, rose oil, and iron filings.

In some embodiments, citricidal can be used in 0.01 g of citricidal/g of Activated Carbon to 1 g of citricidal/g of Activated Carbon. In one embodiment about 30 mgs of citricidal is added to 1 gram of AC. In another embodiment about 20 mgs is added to 1 gram of AC. In yet another embodiment, about 40 mgs is added to 1 g of AC. In yet another embodiment, about 20, about 25, about 30, about 35, about 40, about 45, about 50, about 55, about 60, about 65, about 70, about 75, about 80, about 85, about 90, about 100 mgs of citricidal is added to 1 gram AC.

The contaminants in which the filter can remove include, but are not limited to, heavy metals, hexavalent chromium, and methomyl, bacteria (e.g., E. coli, Clostridium, Camplylobacter, Vibro, Mycobacterium, Shigella, Salmonella, Legionella, or Leptospira. In other embodiments the filter removes viruses (e.g., Coronavirus, Hepatitis, Poliovirus, or Polomavirus), protozoa (e.g., Entamoeba, Cryptosporidium, Cyclospora, Giardia, Microsporidia), parasites (e.g., Schistosoma, Dracunculus, Taenia, Fasciolopsis, Hymenolepis, Echinococcus, multiceps, Ascaris, or Enterobius), and/or fungus as well.

In some embodiments the adsorbent dosage of the activated carbon is about 0.9 grams per 100 ml solution. In other embodiments the adsorbent dosage of the activated carbon ranges from about 0.5 grams per 100 mL solution to about 0.9 grams per 100 mL solution. In other embodiments the adsorbent dosage of the activated carbon ranges from about 0.5 grams per 100 mL solution to about 1 gram per 100 mL solution. In other embodiments, the adsorbent dosage of the activated carbon is at least 0.2 grams per 100 ml solution, at least 0.3 grams per 100 ml solution, at least 0.4 grams per 100 ml solution, at least 0.5 grams per 100 ml solution, at least 0.36 grams per 100 ml solution, at least 0.7 grams per 100 ml solution, at least 0.8 grams per 100 ml solution, at least 0.9 grams per 100 ml solution, or at least 1 gram per 100 ml solution.

In some embodiments a removal efficiency of the impurities is about 30%. In other embodiments, the range of removal efficiency is about 28 to about 30%. In other embodiments the removal efficiency of the impurities at least about 5, 10, 15, 18, 20, 21, 22, 23, 24, 25, 26, 27, 28, 29, 30, 31, 32, 33, 34, 35, 36, 37, 38, 39, 40, 45, 50, 55, 60, 65, 70, 75, 80, 85, 90, 95, 96, 97, 98, 99, or 100%.

### EXAMPLE 1

### Preparation and Characterization of Activated Carbon

In this example, the activated carbon used was produced from coconut shell through the process developed by the Industrial Technology Development Institute (“ITDI”) under the Department of Science and Technology (“DOST”) in the Philippines. The processing of these fallen fruit involved 642 kg of raw coconut shells to be crushed to approximately 1 inch pieces, and screened to eliminate fine particles. A portion of the crushed coconut was then fed to the activation reactor which was designed by ITDI-DOST. The shells were then ignited with kerosene prior to start-up. Once the temperature reached 673.15K, additional coconut was added until the reactor was filled to capacity. The activation process was carried out by supplying steam at a rate of 1.0-1.5 kg/hr to a temperature of 1273.15K for a duration of twelve hours. After processing and activation, 94.75 kg of activated carbon was produced resulting in an overall yield of 14.76%.

Characterization of the activated carbon was done through FTIR analysis using Thermo-Nicolet 6700, Magna-IR spectrometer to determine the surface functional groups. The ITDI-AC was also subjected to pH drift tests as adopted from Ferro-Garcia, to determine the point of zero charge (pH_{PZC}). Sodium chloride solutions with an initial concentration of 0.10 mol/L (1000 L=1 m³) were prepared. The pH of the NaCl solutions are adjusted to values of 3 to 10 using 0.10 mol/L HCl or 0.10 mol/L NaOH solution. Then, 0.10 g of AC sample was added to 50 mL of each solution with adjusted pH. The suspension was constantly stirring for 24 hours, and the pH measured. From the measurements taken, a curve was generated by plotting the final pH values versus the initial pH values. A straight line, signifying where initial pH equals the final pH, was also plotted with the experimental data. The intersection of the two curves is the pH value of the point of zero charge.

### EXAMPLE 2

### Activated Carbon Characterization—FTIR Results

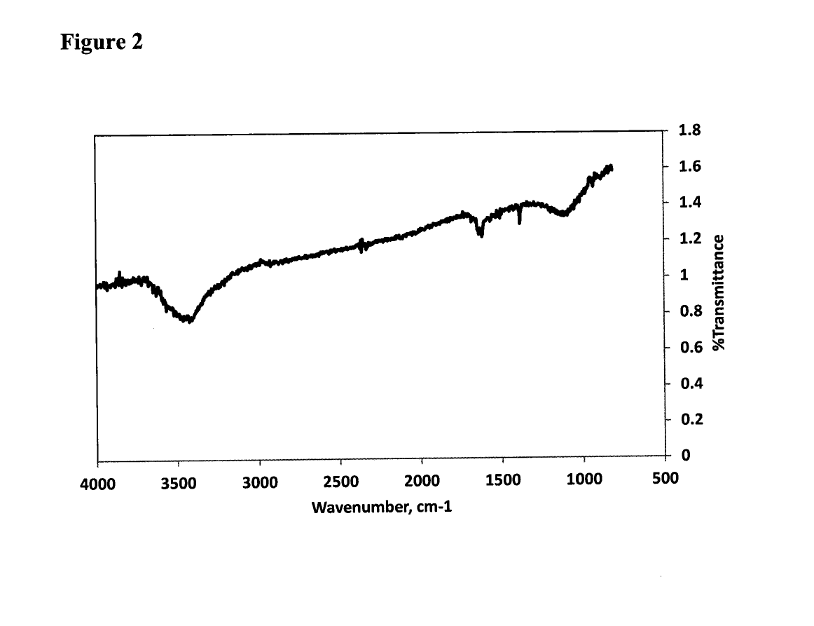

FIG. 2 shows the FTIR spectra of the ITDI-AC sample. As can be seen from the figure, there was a broad peak between 3600 cm⁻¹ and 3300 cm⁻¹. This peak represents the O—H stretching vibrations band that corresponds to the surface hydroxyl groups from carboxyls, phenols, or alcohols (Puziy et al., 2007) and chemisorbed water due to hydrogen bonding (Song et al., 2010). Another peak was observed at 1650-1600 cm⁻¹. This peak represents the aromatic and aliphatic C═C stretching vibrations (Boehm, 2002; Kiran and Kaushik, 2008). The small peak at 1610 cm⁻¹ can be attributed to the presence of quinine groups, which are carbonyl groups connected to aromatic rings (Chingombe et al., 2005).

There was a small peak at 1200-1000 cm⁻¹. This peak may have been due to the C—O stretching vibrations band in alcohols, phenols, esters, or ethers (Tomaszewski et al., 2003; Cabal et al., 2009; Bratkowska et al., 2010). The maximum peak at 1100 cm⁻¹ can be assigned to C—O—C stretching vibrations in aromatic esters (Puziy et al., 2007). In this region can also be included the C—N stretching vibrations of aliphatic amines (Hameed et al., 2008), which is consistent with the presence of primary amines from the peak at 1680-1580 cm⁻¹. Combining these results, it can be affirmed that the surface of the AC contains phenol groups because it both contain aromatic and alcoholic stretching vibrations.

### EXAMPLE 3

### Activated Carbon Characterization—PZC Results

The pH drift test was conducted in order to determine its point of zero charge (pH_{PZC}). This is defined as the state in a solid-electrolyte solution interface at which the total surface charge is equal to zero. This is due to the fact that at this pH, the number of positive ions and negative ions on the surface are equal. For example, the ions that will determine the pH of point of zero charge in a solution of water alone are the positive hydronium ions and negative hydroxide ions. Therefore, the pH of the solution will determine the surface charge of the adsorbent (Pechenyuk, 1999). This is important in adsorption because it will have a bearing on the interaction between the adsorbate and the surface of the adsorbent, especially in aqueous-phase adsorption. If the pH of the aqueous solution is less than the pH_{PZC}, the surface charge is positive and it will attract more negatively-charged or basic adsorbates thus increasing the interaction of its surface with these compounds. Conversely, if the pH of the solution is greater than the pH_{PZC}, the charge of the surface is negative, and it will attract more positively-charged or acidic adsorbates thereby enhancing the adsorption of these compounds (Railsback, 2006). The pH_{PZC} of each AC sample will be determined by pH drift tests adopting the procedure of Ferro-Garcia et al. (1998).

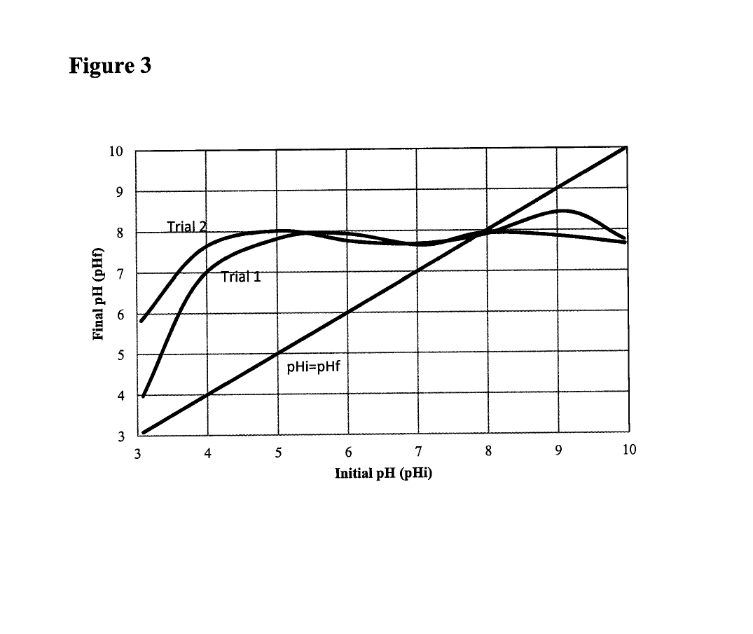

FIG. 3 shows the results of the pH drift tests for the AC samples. As can be seen, the pH_{PZC} based on the intersection of the collected data with the diagonal line (i.e. line indicating where the initial pH equals the final pH) is 7.90 for the first trial and 7.83 for the second trial. Taken together, the average value of pH_{PZC} of the AC sample was calculated to be 7.875.

Based on this result, it can be observed that the surface of the AC sample is slightly basic, caused by the basic functional groups on the surface. The basic nature of AC sample may be due to the pyrone groups on the AC surface and the π electrons of the AC aromatic system (Chingombe et al., 2006). After thermal treatment under nitrogen atmosphere, the PZC value increased from 7.875 to 8.15. This confirms the result of Pereira et al. (2003), in which the surface of the thermally treated AC samples became basic based on the oxygen-containing functional groups with basic nature as seen in their temperature programmed desorption (TPD) profiles. The increase in the value of PZC after thermal treatment under nitrogen was also observed by Franz et al. (2000). It is important to take note that the PZC experiments was conducted in a shaker bath to maintain a constant temperature since the PZC of oxidized AC samples was found out to be decreasing with increasing temperature (Alvarez-Merino et al., 2008).

Correlating the results of the pH drift tests and FTIR analysis, the reduction of the O—H stretching vibration band (between 3600 cm⁻¹ and 3100 cm⁻¹) when thermally treating AC under nitrogen suggests the presence of surface hydroxyl groups. This means that the results of FTIR analysis are consistent with that of pH drift tests, indicating that the surface is basic.

### EXAMPLE 4

### Adsorption Studies—Hexavalent Chromium Removal Results—Adsorbent Dosage Analysis

Batch testing methods were employed to analyze the effect of adsorbent dosage on hexavalent chromium (Cr(VI)) removal. The purpose of this part of the investigation was to obtain an optimal carbon dosage in which contaminant removal per mass of activated carbon was maximized. A series of batch tests were performed using AC with a particle size of 8-16 mesh (0.0012-0.00238 m) and dosages ranging from 0 mg to 900 mg (0 g, 0.150 g, 0.300 g, 0.400 g, 0.500 g, 0.600 g, 0.700 g, 0.800 g, and 0.900 g). The initial concentration of the aqueous chromium solution to be purified was 10⁻⁴ M (16.2 mg/L).

In addition to the carbon, each sample contained 100 mL of chromium solution. After the samples were prepared, each was shaken at a constant rate for 24 hours using an automatic table shaker to give sufficient time to reach equilibrium for the adsorption of chromium in the solution.

Continuous column testing methods were utilized to investigate the effect of contact time on Cr(VI) removal. Rapid small-scale column tests (RSSCT) were used to analyze and obtain the breakthrough curve for the adsorption process of Cr(VI) on ITDI-AC. The column was approximately 1.1 cm in diameter and 30 cm in height and packed with 10 g of ITDI-AC on top of a glass wool support. Each run introduced an aqueous solution of chromium with an initial concentration of 0.0162 g/L to the column. A total of 2 liters of solution was used in each trial. The chromium solution was fed into the column at an average volumetric flow rate of 2.7 mL/min using a multispeed reciprocating pump. Samples of the column effluent were taken every hour until the entire 2 litre sample was passed through the apparatus. Samples were analyzed using a UV spectrophotometer. In order to assess the absorbance, a diphenyl carbazide (DPC) indicator was introduced to the solutions. The light absorbance was used to determine the final chromium concentrations of the aqueous solutions and calculate the percent removal.

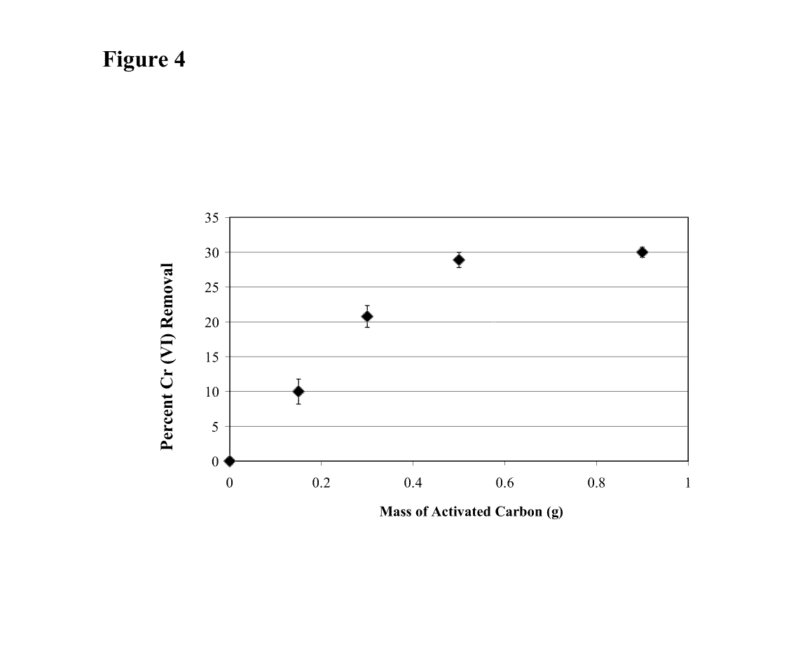

FIG. 4 demonstrates that with an adsorbent dosage of 0.9 grams per 100 mL solution, a removal efficiency of 30% was attained. However, it appears that the optimal range for the adsorbent dose per 100 mL of solution is between 0.5 and 0.9 grams. This range of carbon dosage results in 28-30% removal of chromium.

### EXAMPLE 5

### Adsorption Studies—Hexavalent Chromium Removal Results—Contact Time Analysis

Continuous column testing methods were utilized to investigate the effect of contact time on hexavalent chromium removal. A series of rapid small-scale column tests (RSSCT) were used to analyze and obtain the breakthrough curve for the adsorption process of hexavalent chromium on coconut shell derived AC. Again, the particle size used was 8-16 mesh.

The column was approximately 1 centimeter in diameter and 1 foot in height and packed with 10 grams of coconut shell derived activated carbon on top of a glass wool support. Each run introduced 2 liters of an aqueous solution of chromium with an initial concentration of 16.2 mg/L to the column, using a multispeed reciprocating pump at an average volumetric flow rate of 2.7 mL/min. Samples of the column effluent were taken every hour until the entire 2 liter sample was passed through the apparatus, and analyzed using the protocol from the batch procedure.

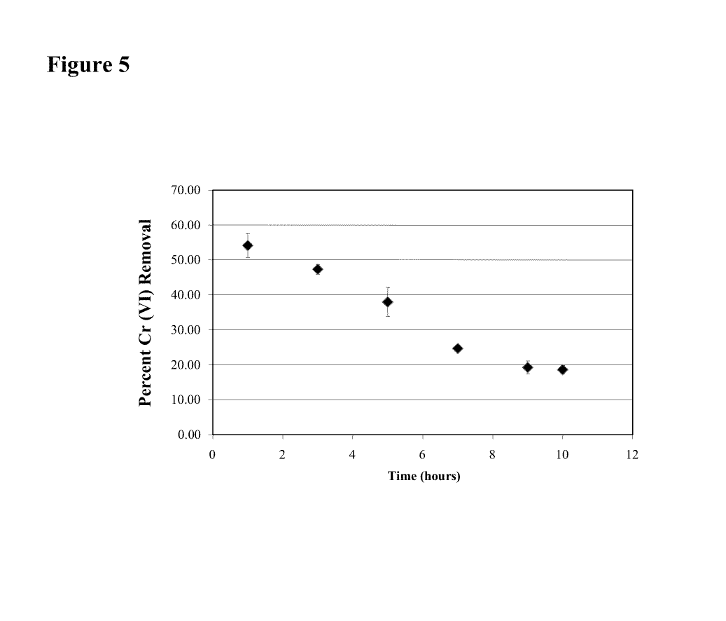

FIG. 5 illustrates the effect of contact time on the removal of hexavalent chromium using coconut shell derived AC. As shown, the percent removal of hexavalent chromium decreases with an increase in contact time. The percent removal is much greater at lower contact times because the activated carbon has uninhabited pore sites and much more surface area for adsorption. However, as contact time increases, the availability of these active pore sites diminishes as more and more of the pore sites are occupied by the hexavalent chromium from the aqueous solution.

The removal of hexavalent chromium using activated carbon derived from coconut shell exhibited tepid, yet promising results. Given the total solution volume of 2 liters, an optimal removal of approximately 55% at 1 hour was achieved. This is a significant percent removal compared to the batch testing method. In order to guarantee enhanced percent removals when compared with batch samples, it is suggested that continuous column adsorbers should operate with contact times of approximately 5 hours or less.

The result obtained may be attributed to the natural pH of this solution (pH=5.1). More specifically, the solution was run at pH<pH_{PZC}, which means that the surface charge is positive, and will attract more negatively-charged adsorbates. Because hexavalent chromium is positively charged, there will be a low affinity between the AC surface with the adsorbate. These results are consistent with the results suggested by the PZC. Additional experiments will be conducted to evaluate the efficacy of hexavalent chromium removal at a pH>pH_{PZC}.

### EXAMPLE 6

### Adsorption Studies—Methomyl Removal Results

Methomyl is a component of the pesticides used in Nagcarlan. The data for the batch adsorption of methomyl on ITDI-AC was fitted to the Langmuir and Freundlich isotherms (Langmuir, 1918; Freundlich, 1906). The linearized forms of these isotherms are shown below, respectively

$$\begin{matrix}\frac{{C}_{e}}{{q}_{e}} = ( \frac{1}{{K}_{L} {q}_{m}} ) + ( \frac{1}{{q}_{m}} ) {C}_{e} & ( 1 ) \\ ln {q}_{e} = ln {K}_{F} + n ln {C}_{e} & ( 2 )\end{matrix}$$

In the equations above, K_{L} is the Langmuir constant (g ITDI-AC/mg methomyl) (1 kg=1×10⁶ mg), qₘ is the monolayer adsorption capacity (mg methomyl/g ITDI-AC), K_{F} (mg methomyl/g ITDI-AC) and n are the Freundlich constants, Cₑ (mg/L) is the equilibrium methomyl concentration, and qₑ (mg/g) is the equilibrium adsorption capacity.

Table 1 shows the parameters calculated after fitting the batch adsorption data into the Langmuir and Freundlich isotherms. The experimental data exhibited a better fit to the Langmuir than the Freundlich isotherm based from the value of R². The value of qₘ and K_{F} was higher than that obtained from the adsorption of methomyl onto a hypercrosslinked polymer MN-500 (Chang et al., 2008). This means that ITDI-AC has the potential to be an effective adsorbent for methomyl from aqueous solutions.

TABLE 1
Parameters of Langmuir and Freundlich Isotherms

| | K_{L} (L/mg) | qₘ (mg/g) | R² |
|---|---|---|---|
| Langmuir | 0.2754 | 9.7847 | 0.9482 |
| | K_{F} (mg/g) | n | R² |
| Freundlich | 4.0759 | 0.2384 | 0.5533 |

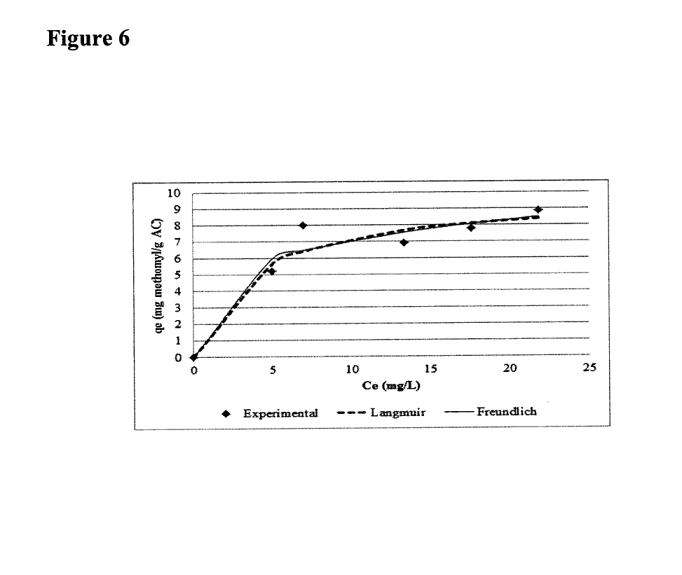

FIG. 6 shows the adsorption isotherm obtained from the batch adsorption of methomyl on ITDI-AC. The parameters from the Langmuir and Freundlich isotherms shown in Table 1 were used to generate the calculated values for the respective lines. As can be seen, both the lines for each isotherm can be considered fitted with the experimental data even though the Langmuir isotherm has a R² value closer to 1.

### EXAMPLE 7

### Adsorption Studies—Methomyl Removal Results

The effect of adsorbent dosage on methomyl removal was also determined using batch adsorption. The particle size of AC used was 0.5-0.6 mm. The initial concentration of the methomyl solution was maintained at a constant value of 100 mg/L. This was based on the pesticide concentration actually used by the farmers on crop application. The method of analysis uses HPLC, and is adopted from the protocol from Chang et al. (2008).

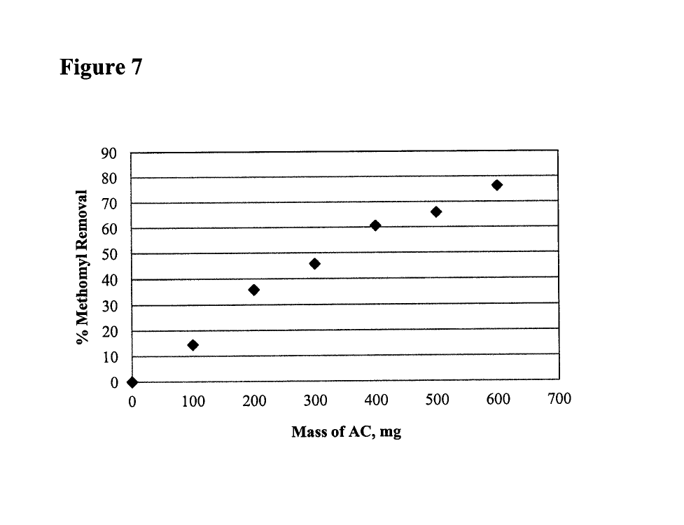

FIG. 7 shows the results of the batch adsorption tests in determining the effect of adsorbent dosage on methomyl removal. As can be seen, approximately 76% removal was achieved when using 600 mg of AC. Moreover, it can be seen that higher adsorbent dosage would mean a higher percent removal for methomyl. The relationship between the adsorbent dosage and percent methomyl removal can be observed to be linear and directly proportional. It can be recommended that the adsorbent dosage can be increased in order to achieve 100 percent removal of methomyl. The adsorption percentage achieved when using marine sediments was only 2% for an equilibrium time of 10 hours (Yang et al., 2005). This means that the activated carbon sample used for the adsorption of methomyl is a better adsorbent than marine sediments.

### EXAMPLE 8

### Disinfection Results

### Preliminary Analysis

During the initial investigation, two proposed natural disinfectants were chosen to be tested: lemon juice and citricidal (i.e. grapefruit seed extract). According to its packaging, this citricidal product (Nutribiotic Inc.) has a concentration of 33% citricidal and the remainder vegetable glycerin. It should also be noted that the manufacturer indicates that there are no additives or excipients.

In order to quantify and compare the antibacterial properties of citricidal and lemon juice, fecal coliform testing was employed. Highly contaminated storm water samples were collected from sources in Bronx, N.Y. The fecal coliform count was determined for 10-mL samples dosed with varying concentrations of citricidal and lemon juice. Three different concentrations of each material were tested, as well as a control without treatment with either agent.

Rapid small scale column testing (RSSCT) was employed using both the coconut shell derived activated carbon and the powdered form of citricidal. A peristaltic pump fed contaminated storm water into a column, with the same dimensions used for Cr(VI) column adsorption, from which samples were collected. Varying doses of citricidal powder were tested and treated samples were compared against untreated samples again using fecal coliform testing. The peristaltic pump operated at approximately 5 mL/min. Thirty 10-mL samples were collected over a course of 2 hours, with a total of 600 mL treated. Three different doses of citricidal have been tested in triplicate: 0.050 g citricidal/g of ITDI-AC, 0.020 g/g, and 0.010 g/g. For each run, 8 g of ITDI-AC was used.

TABLE 2
Lemon Juice and GSE Fecal Coliform Testing Results

| | Concentration | Fecal Coliform |
|---|---|---|
| Sample | (μL per 100 mL sample) | (Colonies per 100 mL) |
| Citricidal 1 | 0.72 | 0 |
| Citricidal 2 | 7.2 | 0 |
| Citricidal 3 | 72 | 0 |
| Lemon Juice 1 | 10 | 44 |
| Lemon Juice 2 | 100 | 26 |
| Lemon Juice 3 | 1000 | 0 |
| Control | 0 | 46 |

As shown in Table 2, citricidal is a more effective antibacterial agent than lemon juice. Even at its lowest concentration, citricidal was 100% effective at removing fecal coliform bacteria from the contaminated storm water. For this reason, citricidal was chosen as the natural disinfection agent for further study.

After this preliminary testing, experiments were conducted using citricidal powder using the aforementioned rapid small scale column testing apparatus in the hexavalent chromium adsorption study. Powder was selected over the liquid concentrate because it is desired to employ citricidal in-situ with coconut shell derived AC, which is granular in form as well. If the liquid concentrate were employed, this would require an additional step pre or post treatment step in the water purification process. In this approach, both citricidal and activated carbon can be combined together in one column to remove contaminants in a single step with only one device. Samples treated with both citricidal and coconut derived AC were matched against both untreated water and samples treated with only activated carbon.

The peristaltic pump operated at approximately 5 milliliters per minute. Thirty ten-milliliter samples were collected over a course of 2 hours, with a total of 600 milliliters treated. Three different doses of citricidal have been tested in triplicate: 50 milligrams per gram of activated carbon, 20 milligrams per gram, and 10 milligrams per gram. For each run, 8 grams of coconut shell derived activated carbon was used. The data from this investigation has demonstrated 100% effectiveness of citricidal and all treated samples have resulted in 100% inhibition of fecal coliform growth, while the untreated samples have been highly contaminated.

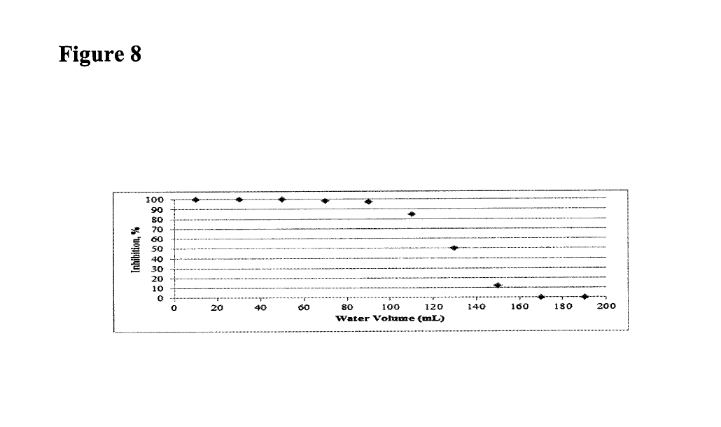

Since even small amounts of citricidal resulted in 100% inhibition, the lowest dose was scaled down by an order of magnitude to 1 milligram per gram of activated carbon in order to generate a breakthrough curve. The purpose of this analysis was to analyze the inhibition activity of citricidal to determine proper scale-up for larger volumes of water. As shown in FIG. 8, only 30 milligrams of citricidal were required to produce 100% e-coli inhibition for at least 50 milliliters of contaminated water, with a fecal coliform count of 2,000 colonies per 100 milliliters.

Patents, patent applications, publications, product descriptions, and protocols which are cited throughout this application are incorporated herein by reference in their entireties for all purposes.

The embodiments illustrated and discussed in this specification are intended only to teach those skilled in the art the best way known to the inventors to make and use the invention. Nothing in this specification should be considered as limiting the scope of the present invention. Modifications and variation of the above-described embodiments of the invention are possible without departing from the invention, as appreciated by those skilled in the art in light of the above teachings. It is therefore understood that, within the scope of the claims and their equivalents, the invention may be practiced otherwise than as specifically described.

1. A portable fluid filtering device comprising a filtering stage that holds a filtering agent.

2. The device of claim 1, wherein the filtering stage is made of a biodegradable material.

3. The device of claim 2, wherein the biodegradable material is bamboo, Japanese knotweed, Bohemian knotweed, Mexican bamboo, smartweed, cactus, sugar cane, river cane, canebreak bamboo, or a hollowed out tree or shrub limb.

4. The device of claim 3, wherein the biodegradable material is bamboo.

5. The device of claim 1, wherein the chamber is a second filtering stage that holds a filtering agent or a container for storing the liquid that passed through the first filtering stage.

6. The device of claims 1-5, wherein the bottom of the filtering stage contains holes.

7. The device of claim 6, wherein the holes are bored at random and covered by a strainer.

8. The device of claims 1-7, wherein the filtering agent comprises activated carbon.

9. The device of claim 8, wherein the activated carbon was prepared from carbonaceous material.

10. The device of claim 9, wherein the carbonaceous material is wood, nutshells, coconut shell, other agricultural materials, or a combination thereof.

11. The device of claim 8, wherein the filtering agent further comprises a citrus fruit extract.

12. The device of claim 11, wherein the citrus fruit extract as citricidal.

13. The device of claim 12, wherein the citricidal is grapefruit seed extract.

14. The device of claims 11-13, wherein the citrus fruit extract may be used in liquid or solid form.

15. A method for filtering the fluid using the device in claim 1 comprising pouring the fluid water into the filtering stage containing the filtering agent and further filtering or disinfecting the fluid with the citricidal.

16. The method of claim 15, wherein the fluid is disinfected by adding the citricidal in solid form to the filtering stage containing the activated carbon or adding the citricidal in liquid form directly to the water in the second chamber.

17. A method of filtering the fluid using the device in claim 1 comprising pouring the fluid water into the filtering stage into a container followed by pouring the liquid from the container into the second filtering stage.

18. The method of claim 17, wherein the second filtering stage contains activated carbon and citricidal.

19. The method of claim 17, wherein citricidal is added directly to the water in the container.
